(19) United States
(12) Patent Application Publication
(10) Pub. No.: US 2004/0165600 A1
(43) Pub. Date: Aug. 26, 2004

(54) Customer site bridged emulated LAN services via provider provisioned connections

(75) Inventor: Cheng-Yin Lee, Ottawa (CA)

Correspondence Address: Law Office of Jim Zegeer, Suite 108, 801 North Pitt Street, Alexandria, VA, 22314, US

(73) Assignee: Alcatel

(21) Appl. No.: 10/369,568

(22) Filed: Feb. 21, 2003

(51) Int. Cl. H04L 12/28

(52) U.S. Cl. 370/395.53; 370/400

(57) ABSTRACT

Methods for provisioning Virtual Local Area Network (VLAN) services are presented. The methods provide for Protocol Data Unit (PDU) transport in service provider and carrier communications networks using tunneling technologies via virtual connections established between Provider Edge equipment (PEs), providing learning bridge functionality at Customer Located Equipment (CLE), while PEs multiplex VLAN traffic onto the tunnels based on VLAN IDentifiers, with each VLAN ID corresponding to a peer remote site participating in a customer VLAN. Advantages are derived from a less restrictive use of VLAN IDs which need only be unique in the access network portion of the service provider's network, Media Access Control ADDRess (MAC ADDRs) tracking is performed only by peer CLEs which store only peer MAC ADDRs, automatic MAC ADDR—VLAN ID associativity determination via the CLE performed learning bridge function, thereby reducing virtual private LAN service provisioning.

### FIELD OF THE INVENTION

The invention relates to bridging private communications networks, and in particular to methods for provisioning emulated local area network services.

### BACKGROUND OF THE INVENTION

A Local Area Network (LAN) is a collaborative environment including interconnected network nodes which share services and exchange information freely therebetween. LAN technologies, such as Ethernet technologies, specified in the IEEE 802 standard which is incorporated herein by reference, enable the interconnection of network nodes within a limited distance typically spanning a building. Ethernet technologies, in particular, support broadcast transmission of information, which enables sharing services and the free exchange of information between network nodes. Ethernet technologies enjoy a very wide use and therefore are supported on a very large portion of installed communications infrastructure. Typically the information is conveyed in accordance with the Internet Protocol (IP) which is widely accepted as a LAN transport protocol.

The typical government organization or enterprise has grown beyond what can be housed in a single building, and many organizations and enterprises are distributed over many sites either in a city, in a country, or internationally. There is a need for sharing services and for exchanging information freely between multiple LAN segments at different sites of an organization or enterprise.

Communications services are provided by service providers concurrently to multiple organization and/or enterprise customers. Service providers typically manage regional public communications networks, generally referred to as Metropolitan Area Networks (MANs), to which customer LANs connect. Service provider communications networks need to provide support of content transport in accordance with the IP protocol because of the wide utilization of the IP protocol in customer LANs. A clash of requirements exists: service providers seek to minimize the amount of content conveyed in the service provider's communications network, while customers need to freely exchange information between different customer sites. The sole use broadcast Ethernet technologies in service provider communications networks is not suited because of the need to conserve transport bandwidth as well because customers require protection of the content conveyed in the service provider communications network from inspection by other service provider customers.

At a higher interconnection level, interconnectivity is provided between service provider communications network MANs via carrier communications networks, the combination forming what are known as Wide Area Networks (WANs). The Internet is a public conglomeration of WANs.

Virtual LAN (VLAN) technologies extend the IEEE 802 standard specification to address customer traffic differentiation in a MAN/WAN environment to provide free exchange of information between LAN segments at different customer sites within a protected emulated LAN context. Providing VLAN support is the most complex and challenging of all Ethernet based services.

VLAN technologies as defined in IEEE 802.1q requires the use of a unique global VLAN IDentifier (VLAN ID) for each customer emulated LAN context. The VLAN ID is to be used globally to tag exchanged information within confines of the customer's emulated LAN context, when conveyed in the service provider's communications network and/or the carrier's communications network. In accordance with prior art solutions, different customer LAN segments associated with the same emulated LAN context and connected to different parts of service providers' communications networks from corresponding sites, would need to share a common globally unique VLAN ID. Depending on the implementation, Customer Located Equipment (CLE) providing connectivity between customer LANs, service provider communications network nodes, carrier communications network nodes need to be configured with globally unique VLAN IDs. As multiple entities such as different customer sites, multiple service providers, and multiple carriers need to differentiate the customer traffic, the limited VLAN ID space available must be carefully managed overall. This introduces a large management overhead as the IEEE 802.1q standard specification only provides for about 4000 useful VLAN IDs and therefore capable to support only up to 4000 customer emulated LAN contexts.

Solutions providing central management of the limited VLAN ID space have been proposed and implemented, however these are not satisfactory as the entity providing the central VLAN ID space management does not necessarily have a direct relationship with each customer. Today, operators, either service providers or carriers, are not able to offer emulated LAN services in a simple, scalable manner to a large number of customers: emulated LAN services have to be manually provisioned which is time consuming, error prone, and require coordination of efforts involving multiple entities to ensure the VLAN IDs are unique throughout.

Another drawback resulting from providing emulated LAN services in accordance with the IEEE 802.1d protocol specification has to do with the amount of Media Access Control ADDRess (MAC ADDR) flooding and learning incurred by all network nodes in the service provider and carrier communications networks between the customer sites. In providing an emulated LAN service, a learning bridge function (IEEE 802.1d) is required to reduce the amount of broadcast information exchanged between remote sites across the service provider and the carrier communications networks. A network node with a learning bridge function learns and keeps track of MAC ADDRs of transmitting nodes to know where to forward Protocol Data Units (PDUs) subsequently. Only if a network node does not know where to sent a PDU, the network node floods the PDU to all ports/virtual interfaces associated therewith (broadcast).

The learning bridge function provides information to a spanning tree protocol executed at each network node in the service provider and carrier communications networks for each emulated LAN context to eliminate PDU transport loops which can potentially establish due to the store and forward nature of the PDU transport in IP communications networks. Network nodes participating in spanning tree determination, exchange Bridge PDUs (BPDUs) therebetween for each emulated LAN context. The broadcast exchange of BPDUs outside of an emulated LAN context represents a management overhead traffic to support emulated LAN services. The computation of spanning trees may uncover multiple lowest cost spanning tree configurations which may lead to instabilities. Because of the unrestrained BPDU exchange, spanning tree instabilities associated with one emulated LAN context may negatively impact other emulated LAN contexts and therefore problems with one customer emulated LAN service may affect the provisioning of emulated LAN services for other customers.

Proprietary solutions have been proposed by Cisco Systems Inc. for the controlled exchange of BPDUs for all provisioned VLAN contexts in a management emulated LAN context which includes reserving VLAN ID 1 for management purposes. While the solution is only available on Cisco Catalyst equipment, the solution also reduces the VLAN ID space available to support emulated LAN services and is therefore undesirable.

Various solutions have been proposed to address the very scarce availability of VLAN IDs and the stringent limitation requiring uniqueness of the VLAN IDs. One such solution was proposed and advanced by Riverstone Networks known as VLAN stacking, a version of which was adopted as the IEEE 802.1ad standard specification referred to as a QinQ solution. The Riverstone/IEEE 802.1ad solution calls for the encapsulation of Ethernet 802.1q VLAN PDUs with another Ethernet 802.1q header therefore providing a two-tier cascaded VLAN ID space (˜4000×4000 VLAN IDs). The intention was to attach the second VLAN ID to PDUs at Provider Edge (PE) equipment to define customer emulated LAN contexts and provider emulated LAN contexts. While the stringent limitations on the uniqueness of the combined QinQ VLAN IDs are reduced somewhat, central coordinated VLAN ID utilization management is still needed to ensure combined VLAN ID uniqueness. This approach does not scale up, requires manual provisioning of the VLAN IDs, and is error-prone. The additional 802.1q header also increases the size of the Ethernet PDUs.

Another drawback associated with QinQ solutions concerns spanning tree determination. In support of QinQ solutions, spanning trees are computed at two levels corresponding to each VLAN ID level. Although the execution of each spanning tree protocol results in a loop free PDU transport at each VLAN ID level, the layered combination of spanning trees may result in PDUs being looped around because coordination of the double exchange of BPDUs in performing the dual spanning tree computation is not provided between the layers.

In providing point-to-point services, such as Ethernet point-to-point connections, MAC ADDRs flooding and learning is not required since PDUs are transported deterministically end-to-end. For this reason point-to-point connectivity was further proposed to reduce, and possibly eliminate, the possibility to: loop PDUs around, reduce the need for intermediate network nodes to flood and learn MAC ADDRs, and relieve the intermediate network nodes from performing the spanning tree determination. The functionality of PEs in providing emulated LAN service support is reduced to management of point-to-point connections. The drawback is that the utilization of resources in the service provider and carrier communications networks may not be optimal, and recovery from network failures is comparatively slow.

Point-to-point connectivity services are not unique to Ethernet technologies. Asynchronous Transfer Mode (ATM) technologies make use of point-to-point connections known as Virtual Circuits (VCs). MultiProtocol Label Switching (MPLS) technologies make use of point-to-point connections known as Label Switched Paths (LSP). Point-to-point connections are also known tunnels.

As Ethernet technologies are not very well suited for bulk transmission of PDUs in the core of communications networks, solutions such as the IETF draft-martini-12circuit-trans-mpls-10 draft published August 2002, referred to as the martini-draft and incorporated herein by reference, propose the conveyance of Ethernet 802.1d/q PDUs over a MPLS overlay communications network in support of VLPS services. The MLPS encapsulation of the Ethernet 802.1d/q PDUs includes an additional MPLS label. MPLS labels are used by the underlying transport infrastructure to multiplex and demultiplex PDU streams onto and from LSP tunnels respectively. The MPLS protocol provides for rerouting of LSPs in case of failure. The arrangement provides for emulated LAN service PDUs to be tunneled through LSPs established between Provider Edge (PE) network nodes. In accordance with this solution, only PEs in the providers' communications networks participate in MAC ADDRs flooding and learning (IEEE 802.1d), and spanning tree determination, reducing the amount of nodes exchanging management traffic compared to QinQ solutions. The amount of BPDU management overhead traffic is reduced because of the reduction of network nodes required to perform the learning bridge functionality however BPDUs are still broadcast in the service provider and/or carrier communications networks between the PEs.

Although not all provider's and carrier's network nodes have to perform the learning bridge function, MAC ADDR flooding and learning performed by PEs still incurs a large overhead. All PEs provisioning the a customer emulated LAN have to track the same number of MAC ADDRs for the emulated LAN. No load sharing among PEs is provided and therefore does not lead to a scalable solution. As the number of MAC ADDRs per customer, and the number of customers grow, PEs may not be able to keep track thereof, and/or keep up with the MAC ADDR flooding, leading to unacceptable PE performance. It is noted that the number of MAC ADDRs tracked is not a function of the number of customers or VLANs provisioned.

Service provider and carrier operators are looking for emulated LAN solutions that are characterized by having minimal impact on existing installed transport infrastructure (such as Synchronous Optical NETwork/Synchronous Digital Hierarchy (SONET/SDH) and ATM), minimum development of new Operational Support System's (OSS) features, minimum development of new processes, and no increase in the operational burden as a result of increased operations staff or increased skills levels. In particular, service providers and carriers are asking for emulated LAN solutions that are simple, scalable, and oriented to a leased-line business model. However, current emulated LAN solutions suffer from: provisioning, traffic engineering, SLA guarantee enforcement, and management complications. Operations management personnel is to be skilled in troubleshooting bridging issues and adept in effecting MPLS/IP/SDH/SONET configuration within a single operational group. The broadcasted BPDU management traffic overhead leads to troubleshooting difficulties, inability to ensure end-to-end Quality-of-Service and security. The manual emulated LAN service provisioning also requires coordination between disparate entities to manual stitch tunnels between communication networks boundaries when the different customer sites participating in an emulated LAN context are not served by the same service provider.

There therefore is a need to solve the above mentioned issues.

### SUMMARY OF THE INVENTION

In accordance with an aspect of the invention, a method of provisioning emulated Local Area Network (LAN) services is provided. The methods provide for Protocol Data Unit (PDU) transport in service provider and carrier communications networks using tunneling technologies via virtual connections established between Provider Edge equipment (PEs), providing learning bridge functionality at Customer Located Equipment (CLE), while PEs multiplex VLAN traffic onto the tunnels based on VLAN IDentifiers, with each VLAN ID corresponding to a peer remote site participating in a customer VLAN. Advantages are derived from a less restrictive use of VLAN IDs which need only be unique in the access network portion of the service provider's network, Media Access Control ADDRess (MAC ADDRs) tracking is performed only by peer CLEs which store only peer MAC ADDRs, automatic MAC ADDR—VLAN ID associativity determination via the CLE performed learning bridge function, thereby reducing virtual private LAN service provisioning.

The advantages are derived from a reduction in the needed skill level of operations management personnel because the learning bridge function can now safely be performed at Customer Located Equipment (CLEs) and controlled by the customers only. Existing Operations Support Systems (OSS) used in provisioning point-to-point services can be leveraged e.g. service provisioning by specify only the two endpoints, Service Level Agreement (SLA) enforcement for the point-to-point service is well-defined, billing, etc. Operators can offer point-to-point Ethernet-based emulated LAN services to end customers in accordance with the same business model used in provisioning: leased lines, Asynchronous Transfer Mode Permanent Virtual Circuits (ATM PVCs), Frame Relay (FR) services, Synchronous Digital Hierarchy/Synchronous Optical NETwork (SDH/SONET) VCs, MultiProtocol Label Switching Label Switched Paths (MPLS LSPs), etc. The encapsulation of Ethernet traffic for point-to-point transport at the transport layer, allows the existing installed network infrastructure to be leveraged with minimal operational impact. The requirement of a simpler features and services set for the Provider Edge (PE) network nodes allows shorter time to market delays for vendor equipment and sought by network operators.

### BRIEF DESCRIPTION OF THE DRAWINGS

The features and advantages of the invention will become more apparent from the following detailed description of the preferred embodiment(s) with reference to the attached diagrams wherein:

FIG. 1 is a schematic diagram showing emulated LAN service provisioning in accordance with an exemplary implementation of an exemplary embodiment of the invention in a single service provider managed MAN environment; and

FIG. 2 is another schematic diagram showing emulated LAN service provisioning in accordance with another exemplary implementation of the exemplary embodiment of the invention in a multiple service provider managed WAN environment.

It will be noted that in the attached diagrams like features bear similar labels.

### DETAILED DESCRIPTION OF THE EMBODIMENTS

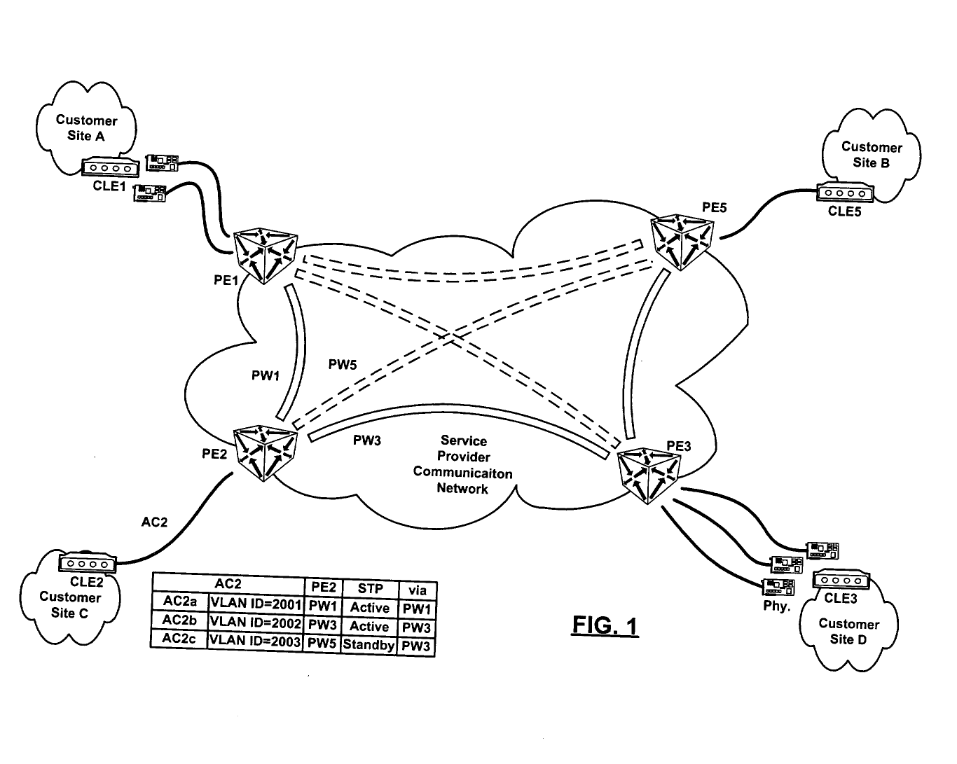

In accordance with an exemplary embodiment presented in FIG. 1, an emulated LAN service is provisioned in a regional service provider's communications network using multiple point-to-point Ethernet service connections provisioned in the service provider network by the network operator: the learning bridge function is performed by Customer Located Equipment (CLEs) while content tunneling is performed at Provider Edge equipment (PEs). Each customer site is served by an emulated LAN service aware CLE. VLAN IDs are used, as multiplexing identifiers in the access network portion of the service provider's communications network, to direct Ethernet traffic to different emulated LAN peer remote sites (CLEs) constituent of a customer emulated LAN. The transport infrastructure used to provision point-to-point Ethernet connection tunnels between PEs is not visible to the CLEs. The proposed solution decouples bridging and the transport/tunneling of PDUs between VLAN peer sites, and ensures that tracking of MAC ADDRs is restricted to CLEs.

The just described emulated LAN service scope limitation to service provider's communications network is not intended to limit the invention, as will be shown herein below, and used only to simplify the description of the relevant concepts.

The simplest access network portion is an access link between a customer's CLE and corresponding the service provider's PE. Ethernet traffic destined to different peer remote sites can be differentiated at the PE by the VLAN IDs used by the CLE to identify peer remote site-specific traffic.

Accordingly, a VLAN ID is no longer used to specify the associativity between a PDU and an emulated LAN context. As a PDU is sent from the CLE to the PE over a site dedicated access link, there is no longer a need to have a globally unique VLAN ID for the service provider's communication network to convey the PDU in directing the PDU to the correct destination.

Provisioning tunnels for traffic to remote sites is performed via and between PEs. At a CLE, no provisioning is required if the CLE has an Ethernet port to each remote peer site. It is worth emphasizing that the VLAN IDs are used solely to multiplex traffic over the access network, and have no reuse as customer emulated LAN context identification.

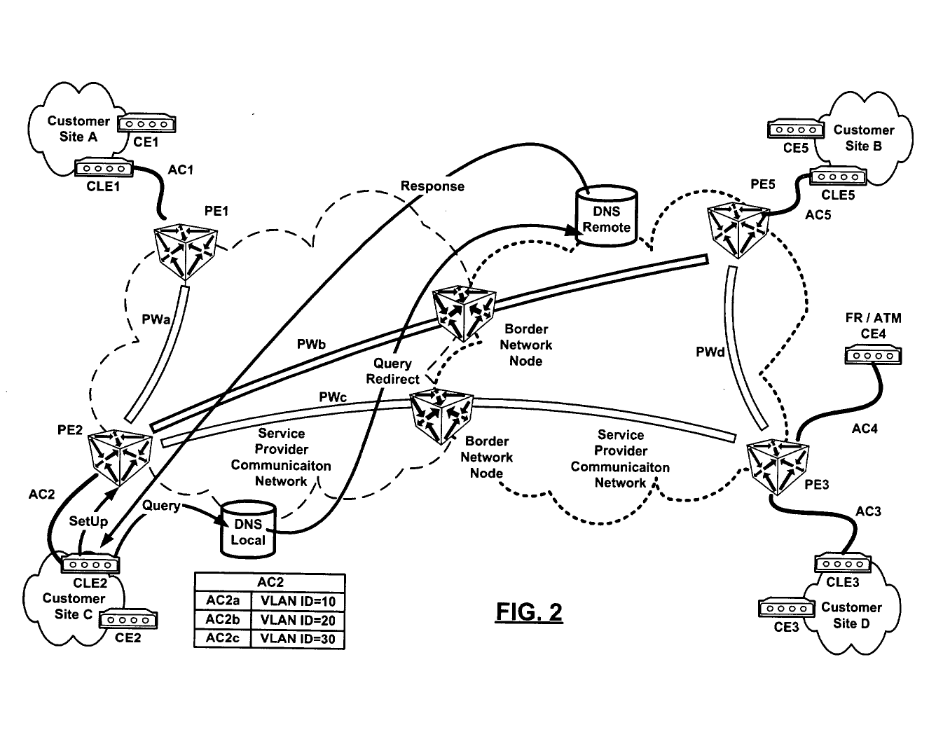

Making reference to FIG. 2, at (each) PE2, emulated LAN peer site specific traffic is switched to the respective point-to-point tunnels (PWa, PWb, PWc) destined to corresponding peer remote sites. Switching PDUs to a corresponding point-to-point tunnel includes the removal of the associated VLAN ID and encapsulating the PDU for transmission in the service provider network in accordance with the particular transport technology (SDH/SONET, MPLS, ATM, FR, etc.) used to provision the point-to-point tunnel. At the remote site, PDUs conveyed via a particular point-to-point tunnel are ascribed remote site specific VLAN IDs to multiplex traffic over the destination access link.

In accordance with the exemplary embodiment of the invention, the removal of the VLAN ID at the ingress PE reduces the need for unique global VLAN IDs, and therefore there is no need for any prior agreement on the VLAN ID values to be used to identify each peer remote site. A range of VLAN IDs may be allocated to each customer site a priori. For example, CLE2 may be allocated (consecutive) VLAN ID values e.g. 10, 20, 30 for use if 4 peer sites participate in an emulated LAN context; and 10, 20, 30, 40, 50 for use if 6 sites participate in an emulated LAN context. At the CLE, only the number of peer remote sites participating in the emulated LAN context has to be configured. Therefore a simple automated procedure for VLAN ID assignment at CLEs and PEs is provided without a need to track VLAN IDs globally for each emulated LAN context.

In accordance with an exemplary implementation of the invention, in provisioning simple emulated LAN services without implementing User Network Interface (UNI) signaling, the customer informs the service provider (offline) of the peer remote sites required to participate in a desired emulated LAN context. The service provider determines which PEs will be involved and establishes fully meshed tunnel interconnectivity therebetween in provisioning the emulated LAN service for the emulated LAN context as shown in FIG. 1. The establishment of point-to-point tunnels may comply with the draft-martini specification, the Ethernet over Layer-2 Tunneling Protocol (L2TP) described in the RFC2661/draft-ietf-I2tpext-pwe3-ethernet-00 specification incorporated herein by reference, Ethernet over ATM RFC1483/2684 specification incorporated herein by reference or, Ethernet over Frame Relay(FR) RFC2427 specification incorporated herein by reference, etc.

In accordance with the exemplary embodiment of the invention, an arbitrary association is provided between the VLAN IDs and the point-to-point tunnels at each PE. In fact each peer customer site may utilize a different VLAN ID space. For example in a four site single emulated LAN scenario, CLEs may make use of [10, 20, 30], [05, 06, 07], [37, 57, 97], [51, 52, 53] VLAN IDs respectively.

In accordance with the exemplary embodiment of the invention, each allocated VLAN ID being associated with a remote peer site, is treated as a virtual port that a standard CLE learning bridge function could flood traffic to and learn MAC ADDRs from to discover dynamically the ports/(virtual) interfaces to which PDUs are to be forwarded. Subsequently PDUs are sent only the virtual VLAN ID port associated with a specific learned MAC ADDR. Note that a mobile network node, such as a laptop computer, can move from site to site without necessitating any provisioning changes, each site CLE learning bridging function simply learns of the changed MAC ADDR to VLAN ID association dynamically.

It may be apparent that the use of fully meshed point-to-point connectivity seems to represent a suboptimal solution, the CLEs also determine the lowest cost spanning tree for the emulated LAN context thereby optimizing resource utilization of the fully meshed point-to-point connections. The results of spanning tree determination may be further provided to the network and link layers to reduce bandwidth reservations over the unused point-to-point links. In accordance with the exemplary embodiment of the invention, due to the results of the spanning tree determination, PDUs destined for different remote peer sites are tagged with a single VLAN ID corresponding to the peer remote site representing a branch point in the active spanning tree. In the event of encountered failures the unused VLAN IDs and corresponding point-to-point connections may be activated by being used to transport emulated LAN context specific traffic.

With the learning bridge functionality constrained to CLEs, no MAC ADDR learning is performed by the PEs. All MAC ADDR flooding and BPDU exchanges are tunneled to the all peer remote sites only. All MAC ADDR flooded traffic and BPDUs exchanged between the CLEs is seen in the service provider's (and, as will be presented herein below, the carrier's) communication network as customer traffic and may be billed accordingly. Instabilities in computing spanning trees can be limited to a customer emulated LAN context by imposing traffic bandwidth limitations on the point-to-point tunnels, a service provider management function. In fact the service provider may not even be aware of the provisioned emulated LAN connectivity over the provided mesh of point-to-point connections.

If a customer requires multiple emulated LAN services to be provisioned in parallel between common customer peer sites, the allocated VLAN IDs to the emulated LAN contexts must be unique in the access link between the CLE and the PE. The local uniqueness may be simply ensured by choosing different VLAN ID ranges for each emulated LAN context if 4000 VLAN IDs are enough to provision all emulated LANs concurrently, using QinQ solutions over the access link to differentiate between emulated LAN contexts either as a matter of preference or to provide access to more VLAN IDs for customers with large numbers of remote peer sites, or using multiple access links if very large numbers of VLAN IDs are required for example in support of teleworking solutions.

QinQ solutions may be used over the access link only if the customer already uses VLAN ID tagging for example to differentiate between departmental traffic. As was mentioned herein above, Ethernet technologies use broadcast transport to convey PDUs between network nodes. Even in a customer LAN control over specific conveyed PDUs may be necessary. Take for example, biographical information exchanged between human resources departmental computers. Whether the human resources departmental computers participate in a single customer LAN at a single site or participate in disparate customer LANs at different customer sites, the PDU traffic bearing human resources information must be differentiated from the rest of the traffic exchanged in the customers LAN(s) and the customer emulated LAN context for encryption. The separation may be provided by relegating the human resources traffic to a customer provisioned emulated LAN using a customer assigned VLAN ID. In accordance with this deployment scenario, when the human resources traffic tagged with the customer's VLAN ID reaches a CLE to traverse over to another customer site, the PDUs may be tagged again using (for example QinQ solutions) for transport over the access link to the PE.

Offline approaches to emulated LAN provisioning may not be timely enough for certain applications. Automated approaches are proposed herein below with reference to User-Network Interface (UNI) signaling.

An emulated LAN may span different interconnected communications networks for example between two service provider communications networks. FIG. 2 shows VPLS service provisioning between VLAN context associated remote peer sites connected to different service providers of a Wide Area Network (WAN). Manual provisioning of point-to-point connections requires manual stitching point-to-point connections across the boundary. Manual stitching of point-to-point connections may be adequate for small scale permanent emulated LAN service provisioning but may not be time efficient. Another issue is that of splicing the computed spanning trees and/or full meshed connections.

In accordance with the exemplary embodiment of the invention, UNI signaling, similar an ATM UNI, may be used to request establishment of point-to-point Ethernet tunnel connections across independently managed communications network boundaries, including the specification of Service Level Agreement (SLA) parameters such as bandwidth. In accordance with a simple scenario, customer site CLEs are assigned network addresses (e.g. IP addresses). A customer may indicate the network address of remote peer sites to which point-to-point tunnels connections are required. An apparent disadvantage of using UNI signaling is the need to provide CLEs with network addresses of remote peer site CLEs.

The disadvantage can be overcome by having the CLEs query a Remote Access Dial-In User Service (RADIUS) server at a customer's corporate head office, or a RADIUS server at a service provider's network, to retrieve the remote peer site IP addresses as described in IEFT draft-lee-ppvpn-ce-auto-config-01.txt which is incorporated herein by reference.

Another solution includes employing services provided by the Border Gateway Protocol (BGP) in discovering and distributing information regarding PEs associated with the remote peer customer sites. The customer may not necessarily be the emulated LAN manager.

Yet another solution includes the use of Domain Name Services (DNS) to automatically obtain remote peer site remote addressees. In querying a DNS server, a CLE at a site may use heuristics to formulate the DNS query. For example, a customer uses fully qualified names to refer to each emulated LAN context such as “customerVPL1” and has remote peer sites served by known service providers such as: ATT, MCI, and SBC. Globally the peer customer sites are therefore known as “customerVPL1.att.net”, “customerVPL1.mci.net”, and “customerVPL1.sbc.net”, and understood to participate in the same “customerVPL1” emulated LAN. Each service provider communications network domain knows how to direct “att.net”, “mci.net”, “sbc.net” queries to the appropriate service provider DNS server and each service provider server will return a served site CLE network address based on the “customerVPL1” name. This approach does not require a single entity to manage emulated LAN provisioning and deployment. Certainly if a DNS server of one of the service providers (ATT, MCI, or SBC) does not cooperate, only the customer site served by that service provider may not be able to participate in the emulated LAN without affecting emulated LAN provisioning to the other customer sites.

Once the network addresses (or location) for the remote peer site CLEs are known, each CLE, using UNI signaling, may request the establishment of point-to-point tunnels between the corresponding PEs. From the request for point-to-point tunnel establishment, each PE negotiates VLAN ID assignment for the emulated LAN context.

The original idea behind DNS was to make information easily available all over the Internet. The Internet neighborhood is no longer a friendly place anymore. Organizations have a legitimate need to hide certain parts of their namespace from most of the world while making it available on a limited basis behind a firewall for example. Methods of restricting DNS queries to prevent unwanted rogue participation in an emulated LAN context are known.

It is important to emphasize that in accordance with the proposed solutions presented herein with reference to the exemplary embodiment of the invention, each CLE associated with a peer customer site does not have to indicate remote peer site network addresses, multiplexing VLAN IDs, or the correspondence between the VLAN IDs and the remote peer sites. This greatly reduces the amount of provisioning required at the CLE. The customer CLE must convey to the service provider PE the remote peer sites to which an emulated LAN service is required. The remote peer sites which are to participate in the emulated LAN context is the customer's choice.

To reduce the provisioning required, without utilizing specific protocols, a convention of using consecutive VLAN ID tags or multiplexing IDs may be used to eliminate the assignment thereof by specifying only the number of remote peer sites. A convention of assigning multiplexing VLAN ID tag values at a CLE and PE and the mapping of an Access Circuit (AC) to the appropriate point-to-point tunnel can be used to reduce the provisioning required on CLEs/CEs and PEs. CLEs/CEs can be pre-provisioned with a range of reserved VLAN ID tag values or multiplexing IDs, used to multiplex traffic to different remote CEs. For example, the CLEs/CEs in FIG. 1, where PE2 has two point-to-point connections PW1 to PE1 and PW3 to PE3, have reserved 100 VLAN tags, 2001-2100 each for this purpose. The customer wants to have two point-to-point Ethernet services from CLE2 to CLE1 and CLE3. The provider may use a Link Management Interface (LMI) or other means to provision CLE2, or may have the customer configure CLE2 via an interface to connect to the two remote CLEs. This is the only configuration required at the CLE when remote CLE(s) that this CLE should connect to, are added or removed.

CLE2 may then allocate VLAN ID tags 2001 and 2002 for these two connections. PE2 expects CLE2 to use VLAN ID tag 2001 and 2002 and shall map VLAN ID tag 2001 to the first PW1 and 2002 to the second PW3, the mapping of VLAN ID tags to PWs can be arbitrary if there are no specific requirements for the PWs (different SLAs). If a new CLE5 is added, the number of remote CLEs to connect to at CLE2 shall be configured to three and VLAN ID tag 2003 shall be allocated for the new point-to-point connection to the CLE5. If CLE3 is removed, the number of remote CLEs to connect to at CLE2 shall be changed to two, and the virtual port association (VLAN 2002) for the point-to-point connection PW3 shall be changed to VLAN 2002.

Note that this change of VLAN ID tags to virtual port association should not affect the status of the virtual port. The reason to change the VLAN ID tag association is to ensure that consecutive VLAN ID tags are used for the connections to the remote peer CLEs. Otherwise states would have to be maintained in PE2 to remember what VLAN ID tags are being used, what VLAN ID tags are no longer used when CLEs are removed, and what VLAN ID tags can be reused when CLEs are added subsequently. Using the above convention it is not necessary to use specific protocols to reduce the provisioning of CLEs.

UNI signaling may also be used in trimming down unused bandwidth on point-to-point tunnels in a full mesh deployment in deactivating point-to-point tunnels in accordance with the determination of the spanning tree.

Ultimately, if the learning bridge function is used to control and trim down the point-to-point tunnels originally established, peer CLEs at remote peer customer sites will act as either a spoke or a hub. There may be more than one hub in the emulated LAN topology. A hub CLE will tag PDU traffic with at least two VLAN IDs.

A spoke CLE will tag all PDU traffic associated with an emulated LAN context with a single VLAN ID for transport, via the corresponding access link, over to a hub in accordance with the determined spanning tree even though the actual PDU traffic is destined for different remote peer customer sites. If the access link is used exclusively for the emulated LAN service, then no VLAN ID tagging is needed at all, the PE automatically switching all traffic from the access link to the point-to-point connection destined for the hub.

The invention was described herein above with reference only to point-to-point connection tunnels to simplify the presentation of the relevant concepts. In conveying broadcast PDUs over the access link, the CLE replicates the PDU and sends the replicas via corresponding VLAN ID virtual ports. This increases bandwidth utilization in the access network. The use of the spanning tree may limit the replication of PDUs while does not eliminate the replication.

The invention is not limited to point-to-point connection tunnels, for a customer having a very large number of remote peer sites, the customer may subscribe to a point-to-multipoint Ethernet service and be assigned a VLAN ID for that service. A point to multipoint service is another type of service which providers can offer without incurring overheads related to MAC ADDRs forwarding states at network nodes in the service provider communications network. The difference between point-to-point and point-to-multipoint services is that point-to-multipoint services require replication of traffic for a VLAN ID, to multiple point-to-point tunnels at a PE. The PE replicates and transmits the VLAN ID tagged traffic to all the branch point-to-point tunnels of the point-to-multipoint service. Therefore bandwidth efficiencies may be achieved in the access network if broadcast/multicast traffic replication and forwarding is performed by a PE.

The invention is not limited to the use of VLAN IDs to differentiate between PDU traffic destined for a different remote peer site. The exemplary use of VLAN IDs is associated with the use of Ethernet technologies in the access network. If different technologies are used in the access network, different access connection identifiers are needed in order to access the different peer remote sites. For example, if a Frame Relay (FR) link is used in the access network to provide connectivity to a customer site, then the different peer remote sites of the emulated LAN context, regardless of the technologies used for their individual access network portions, are differentiated between at the customer site via the use of multiple DLCI identifiers. Therefore heterogeneous access technologies can be supported in an emulated LAN context. The separation achieved between the requirements of provisioning emulated LAN services and the transport technologies used in the access network, enables service providers to leverage the existing installed infrastructure and eases the migration to new network infrastructure when needed without affecting provisioned emulated LAN services.

In the above homogeneous end-to-end connectivity was described wherein, all remote peer sites participating in an emulated LAN context make use of the same technologies e.g. Ethernet. The invention is not limited thereto, heterogeneous end-to-end connectivity may also be supported. In using different technologies in the access network, for example using a FR access link, PDUs identified by DLCI identifiers to be destined to a specific peer remote site, are conveyed across a FR access circuit associated with the DLCI identifier. The provisioning of the emulated LAN service includes provisioning of attachment circuits between the CLE and the PE. The use of FR technologies is not unique in this regard, the use of ATM technologies in the access network requires provisioning ATM VC associated with Virtual Path Identifiers/Virtual Circuit Identifiers (VPI/VCI). The CLEs bridge traffic over the different attachment circuits.

In accordance with an exemplary deployment scenario, customer sites may be served via FR access links between the customer's CLE to the service provider's network to a PE. The overall end-to-end connectivity is provisioned via a Frame Relay (RF) or ATM access link at one end, and an Ethernet access link at the service provider's end. Such hybrid end-to-end connectivity is typically used to convey Internet Protocol (IP) PDUs (and to a lesser extent Ethernet PDUs). The emulated LAN service proposed in accordance with the exemplary embodiment of the invention, may be extended to this deployment scenario by employing routing equipment/entities at each (CLE) remote peer site participating in an emulated LAN context and the hybrid end-to-end connectivity passing in the service provider's network through a border network node where it can be cross-connected to an Ethernet point-to-point tunnel. Because MAC ADDRessing may not be a feature provided at the FR CLE end, the Ethernet end would have to emulate a virtual MAC ADDR and to resolve IP addresses to MAC ADDR mapping(s). The end result is that the CLE terminating the hybrid point-to-point connection appears as a regular network node (albeit a virtual one) to each of the remote peer site CLE routers participating in the emulated LAN and the overall broadcast network, and only one identifier (DLCI or VPI/VCI) is needed for participation in the emulated LAN context.

Further details are provided herein with reference to an exemplary deployment and configuration router peering scenario supported in accordance with the exemplary embodiment of the invention:

Abbreviations used in the following description:

AC Attachment Circuit

CE Customer Edge

CLE Customer Located Equipment

PE Provider Edge

PSN Packet Switched Network (service provider/carrier network)

PW Pseudo-Wire (point-to-point connection)

A provider may offer a service which enables CE routers connected to different access links to peer with each other (e.g. a CE router may be connected to an Ethernet network segment and is allowed to peer with another router connected to Frame Relay (FR) network segment). If the CE performs bridging functionality, Ethernet frames may be decapsulated at the Frame Relay end, transported over the PW, and subsequently decapsulated at the Ethernet end of the heterogeneous end-to-end connection, and forwarded to an AC, as described above for homogeneous PW. In this case, if the CEs also have routing capabilities, and the payload at the Frame Relay end is not Ethernet but IP. Hence different procedures are required to successfully convey content via the heterogeneous PW end-to-end, and described in the following paragraphs.

In accordance with a typical Layer 2 Virtual Private Network (L2VPN) deployment, a customer may have some sites with Ethernet access links and some with FR access links, please refer to FIG. 2, a CE4 with an FR UNI is connected to PE3.

If the CEs are routers, CE1, CE2 and CE3 may peer over the emulated LAN—discovering the IP addresses of each via a routing protocol and the corresponding MAC addresses using ARP over the emulated LAN.

It would be useful to allow a CE4 with FR interface to the provider to peer with the other routers (CE1, CE2, CE3) in the emulated LAN context.

[Note: Other alternatives, described herein below, include having CE4 peer with one or more routers on a different subnet. CE4 would need to be configured with a point-to-point link to one or more routers. The IP forwarding would be less optimal in that PDUs may have to traverse through additional hops to reach routers in the emulated LAN.]

All IP multicast/broadcast traffic on emulated LAN will be transported to the CE router with FR access. All IP multicast/broadcast traffic from the CE router with FR access will be seen on the emulated LAN. Essentially, CE4 appears as a station/node on a LAN to other CE routers. Although CE4 has an FR access link, CE4 is able discover other routers on the emulated LAN if the OSPF Interface Type of the FR link is set to broadcast type. Note that CE4 is a router and need not have bridging functions. From the L2 perspective, CE1, CE2 and CE3 see a (emulated) LAN and CE4 has a FR access link. From the IP layer perspective in CE1, CE2, CE3 and CE4, all these CE routers appear to be connected in the broadcast network associated with the emulated LAN context, and hence all the routers can peer with each other.

To allow a CE with FR interface to peer with other routers on an emulated LAN, a mechanism which allows IP PDUs to be transported from an FR interface to an Ethernet interface is required and is referred to as a heterogeneous PW with IP payload.

IETF draft-shah-ppvpn-arp-mediation-01, incorporated herein by reference, describes a similar feature. In the Shah proposal, the interworking procedures between CEs using different address learning techniques, for instance, one using ARP on Ethernet and the other using Inverse ARP on Frame Relay are specified. In accordance with the Shah proposal, the router associated with the FR access link can only peer on a one-on-one basis with a single one other router associated with an Ethernet access link.

In accordance with the exemplary embodiment of the invention, a CE with FR access link is enabled to peer and discover other routers in an emulated LAN, and CEs in the emulated LAN can discover a CE with FR access link as if participating in the same LAN. The advantages of the proposal are:

many routers with FR access links could peer on a broadcast network associated with the emulated LAN context (instead of configuring meshed of point-to-point links on different subtends, which requires more configuration on the CE routers);

using a emulated LAN and the overall broadcast network to peer routers reduces the number of adjacencies required. This in turn reduces the amount of routing protocol traffic and the size of the link-state database, as described in RFC2328 incorporated herein by reference; and

on a CE, only one FR DLCI is required, to peer with other routers associated with the emulated LAN and the overall broadcast network.

The heterogeneous PW service, transports IP traffic to a CLE performing bridging for the emulated LAN, CLE2 in the above example. CLE2 has a VLAN tag (or stacked VLAN tag) assigned for this heterogeneous PW service. CE4 would have a DLCI assigned for this heterogeneous PW.

If both access links are point-to-point in nature, providing a heterogeneous interworking feature is simpler (FR-ATM interworking is one example). However, the shared and multiple access nature of Ethernet requires additional link layer processing.

When the IP traffic encapsulated over FR is received at PE3, PE3 decapsulates the PDU, and tunnel the IP PDU over the PSN as described for the appropriate tunneling technology. Since both ends use different link layer technology, it is not useful to include the link layer header and the heterogeneous PW is concerned with tunneling higher layer, i.e. IP traffic, only the IP PDU is transported over the PSN.

When PE2 receives a PDU over the heterogeneous PW, it PE2 decapsulates the PDU, to obtain the IP PDU. PE2 knows the Access Circuit (AC) it should forward PDUs to, i.e. AC2c and the service multiplexing ID (VLAN/Stacked VLAN tag) to use.

The IP destination address of the PDU is known, but the corresponding link layer or MAC address is not known. Note that for a homogeneous Ethernet PW, the link layer technology is the same at both ends of the PW. The link layer address is included at the ingress end of the PW, and the egress end forwards the decapsulated PDU to the appropriate AC. With heterogeneous PW, the link layer address of the IP address is not included in the PW. In order to resolve the MAC address, a functional element, is required to figure out the corresponding link layer address (MAC address) of the IP address.

If the IP PDU is multicast, the corresponding MAC address can be derived from the IP multicast address. A reserved (broadcast) MAC address corresponds to the IP broadcast address. This function is referred to as IP multicast to MAC address derivation.

If the IP PDU is unicast, a functional element, known as a Proxy ARP client, finds out the corresponding MAC address by sending an ARP request. The Proxy ARP client (and IP multicast to MAC address) functions may be located at PE2 or the CLE2.

When the proxy ARP client is located at PE2, If the MAC address corresponding to the IP destination of the PDU decapsulated at PE2 is already resolved, PE2 may append the link layer/Ethernet header to the PDU and forward it over AC2c.

Otherwise, PE2 sends an ARP request for the MAC address of the IP destination address over AC2c. The ARP message is encapsulated in the appropriate link layer information and is broadcasted in the emulated LAN context.

When PE2 receives an ARP response from the corresponding IP node, PE2 caches the MAC ADDR learned for the IP address in a table. PE2 now knows the MAC Destination ADDR to use for the IP address.

The Ethernet header fields for PDUs destined to the IP node are set as follows:

Source Address is filled with the virtual MAC ADDR of CE4;

Destination Address is filled with the MAC ADDR corresponding to the IP address;

VLAN ID is set the value assigned to the heterogeneous PW service and corresponding to AC2c; and

the (sub) EtherType is set to IP.

When CLE2 receives the PDU, it bridges it like any other Ethernet PDU, towards the destination node.

When the proxy ARP client is located at CLE, and PE2 receives a PDU over the heterogeneous PW, PE2 decapsulates the PDU, to obtain the IP PDU. PE2 knows the AC it should forward PDUs to, i.e. AC2c and the service multiplexing VLAN ID (VLAN/Stacked VLAN tag) to use.

PE2 shall forward the IP PDU to AC of the PW.

The Ethernet header fields are set as follows:

Source Address is filled with the MAC ADDR of PE2;

Destination Address is filled with the MAC ADDR of CLE2;

VLAN ID is set the value assigned to the heterogeneous PW service corresponding to AC2c; and

the EtherType is set to IP.

When CLE2 receives the PDU destined to it, CLE2 inspects the PDU.

If the corresponding MAC ADDR is not known and CLE2 is also a router, it shall attempt to forward the IP PDU, and sends an ARP request for the appropriate MAC ADDR for the next hop (or destination, if on the same subnet), as a router would.

If the MAC ADDR is not resolved yet, and CLE2 does not route, CLE2 sends an ARP request for the MAC ADDR corresponding to the IP destination address on the emulated LAN.

When the MAC ADDR is resolved, the Ethernet header fields of the corresponding IP PDU are set as follows:

Source Address is filled with the virtual MAC ADDR of CE4;

Destination Address is filled with the MAC ADDR corresponding to the IP address; and

the EtherType is set to IP.

CLE2 bridges the Ethernet PDU appropriately, adding any VLAN ID tag as required.

Note that a Proxy ARP Server (described herein below) associated with the AC of a heterogeneous PW, on CLE2, prevents ARP messages from being sent over the PW to the Frame Relay end of the PW.

The advantages of having a Proxy ARP client at CLEs are:

the mapping of customer's MAC ADDR to a corresponding customer's IP address is not cached in PEs, although the number of MAC ADDRs in most cases may be the same as the number of CE routers;

no ARP messages are conveyed from service provider's network to customer site and vice-versa;

there is no need to manage virtual MAC ADDRs in PEs

The Proxy ARP Server may reside on CLE2 or PE2. If PE2 is a Proxy ARP Client, then PE2 must be a Proxy ARP Server, similarly for CLE2.

CE2 and other routers in the emulated LAN discover the IP address of CE4 via a routing protocol used on the emulated LAN. When CE2 or other routers send an ARP request for the MAC ADDR of CE4, the Proxy ARP Server(s) intercept the broadcast ARP request. The Proxy ARP Server on CLE2 responds with the CE4 virtual MAC ADDR. Other Proxy ARP Servers ignore the ARP message. The bridging function in the emulated LAN learns the CE4 (virtual) MAC ADDR in the same way as learning the MAC addresses of any other nodes on the emulated LAN.

A routing protocol like OSPF on the CE4 should be configured with InterfaceType broadcast mode to allow OSPF to learn of the other CE routers on the emulated LAN. OSPF on CE2 and other CEs should also be configured to be of InterfaceType broadcast, if connected to the emulated LAN. A CE router connected to peer point-to-point with another CE router on a different subnet should be configured with InterfaceType point-to-point.

The embodiments presented are exemplary only and persons skilled in the art would appreciate that variations to the above described embodiments may be made without departing from the spirit of the invention. The scope of the invention is solely defined by the appended claims.

I claim:

1. A method for provisioning an emulated LAN service comprising steps of:
a. provisioning point-to-point connections in a communications network between a plurality of provider edge (PE) network nodes associated with a plurality of customer peer sites participating in the emulated LAN service; and
b. switching, at each PE, Protocol Data Units (PDU) received via an access link servicing a corresponding customer site and tagged with multiplexing identifiers corresponding to a remote peer site, onto corresponding a point-to-point connection;
whereby a plurality of access nodes, each coupled to a respective edge node PE, each being operable to perform a learning bridge function, including MAC address learning and flooding.

2. The method claimed in claim 1, further comprising: tagged, each PDU transmitted from each source access node to the corresponding edge node PE, with a multiplexing identifier corresponding to a destination remote peer site, wherein the multiplexing identifier is unique only over the access link between the access node and the provider edge network node.

3. The method claimed in claim 2, wherein tagging step is omitted if a plurality of access links are employed between the access node and the corresponding provider edge network node, the plurality of access links corresponding to the plurality of remote peer sites, the method further comprising a step of: switching PDUs at the provider edge network node from an access link to a corresponding point-to-point connection associated with a remote peer site.

4. The method claimed in claim 1, wherein at least one point-to-point connection comprises a multiplexed tunnel from an MultiProtocol Label Switching (MPLS) connection, an Internet Protocol (IP) connection, and an Asynchronous Transfer Mode (ATM) connection.

5. The method claimed in claim 2, the method further comprising a step of consecutively assigning multiplexing identifiers to remote peer sites.
